(19) United States
(12) Patent Application Publication
(10) Pub. No.: US 2023/0050962 A1
(43) Pub. Date: Feb. 16, 2023

(54) METHOD FOR DOSING COAGULANT AND ADSORBENT IN A MEMBRANE FILTRATION SYSTEM

(71) Applicant: Dupont Safety & Construction, Inc., Wilmington, DE (US)

(72) Inventors: Christian STAAKS, Munich (DE); Michael HOFFMAN, Raisting (DE)

(73) Assignee: Dupont Safety & Construction, Inc., Wilmington, DE (US)

(21) Appl. No.: 17/875,911

(22) Filed: Jul. 28, 2022

Related U.S. Application Data
(60) Provisional application No. 63/230,335, filed on Aug. 6, 2021.

(51) Int. Cl. C02F 1/28; C02F 1/44

(52) U.S. Cl. CPC C02F 1/281; C02F 1/444

(57) ABSTRACT

A method for membrane filtration of water comprising alternating in-line additions of coagulant and adsorbent to the water upstream of the membrane, wherein each addition time is in a range from 10 seconds to one hour.

### TECHNICAL FIELD

The invention is generally directed toward a method for dosing coagulant and activated carbon to water in a membrane filtration system.

### BACKGROUND

Coagulant dosing before membrane filtration of waste water is well known process used to stabilize and improve membrane performance in dead-end operation for low pressure membranes, typically applied for water sources rich in organics. The addition of coagulants can provide a stable operation by generating a removable and reversible fouling layer and also can reduce total organic carbon (TOC) due to dissolved organic matter. Coagulants are typically inorganic metals based on iron or aluminum, which and can be a major part of operational costs in ultrafiltration plants. They are typically dosed continuously in a central pipe before the treated water is distributed to different filtration units or racks. A filtration cycle in dead-end operation for membrane filtration using low pressure membranes consists of a filtration time and a hydraulic cleaning time. JP5349378B2 discloses a method for dosing a chemical coagulant and activated carbon to a mixing tank prior to a membrane filter, but does not disclose an efficient method for effectively dosing both coagulants and adsorbents directly in-line in this type of system.

### SUMMARY

A method for membrane filtration of water comprising alternating in-line additions of coagulant and adsorbent to the water upstream of the membrane, wherein each addition time is in a range from 10 seconds to one hour.

### DETAILED DESCRIPTION

Preferably, the water to be filtered in this invention is water containing impurities which are removable using ultrafiltration (UF), e.g., organics having molecular weights above the cut-off for the membrane, particulate matter, microorganisms, etc. Preferably, the water is waste water from a water treatment process, preferably aqueous effluent from a municipal waste water treatment plant. Preferably all operations described herein are performed at ambient temperature unless otherwise specified.

Preferably, the water in-line prior to addition of adsorbent or coagulant has a pH in the range from 5 to 8.5, preferably from 6 to 7.8. Preferably, the temperature of the water in-line prior to addition of adsorbent or coagulant is from 5 to 40° C., preferably at least 8° C.; preferably no more than 35° C., preferably no more than 30° C., preferably no more than 25° C. Preferably, the water in-line prior to addition of adsorbent or coagulant has a turbidity from 1 to 300 NTU, preferably at least 1.5, preferably at least 2; preferably no more than 100 NTU, preferably no more than 50 NTU.

The time period for alternating additions of coagulant and adsorbent to the water in-line is from 10 seconds to one hour, i.e., coagulant is added for a time period from 10 seconds to 10 minutes, followed by addition of adsorbent (without coagulant) for a time period in the same range, then followed by another addition of coagulant, etc. A time period for addition of coagulant and a time period for addition of adsorbent are not necessarily the same provided that each is in the stated range. The time periods for addition of either component also may vary within the range, e.g., individual coagulant additions may occur over different time periods within the range, and/or individual adsorbent additions may occur over different time periods within the range. Preferably, a time period is at least 30 seconds, preferably at least 1 minute, preferably at least 1.5 minutes, preferably at least 2 minutes; preferably no more than 30 minutes, preferably no more than 15 minutes, preferably no more than 10 minutes, preferably no more than 8 minutes, preferably no more than 6 minutes, preferably no more than 5 minutes, preferably no more than 4.5 minutes, preferably no more than 4 minutes. Preferably, a ratio of the median time period for coagulant additions to the median time period for adsorbent additions is from 3:1 to 1:3, preferably 2:1 to 1:2, preferably from 1.5:1 to 1:1.5, preferably from 1.3:1 to 1:1.3. Preferably, any gap between a coagulant addition and prior or succeeding adsorbent addition is no longer than 1 minute, preferably no longer than 30 seconds, preferably no longer than 15 seconds.

The coagulant and adsorbent are added to the water in-line, i.e., directly into a line in fluid communication with a membrane filter without use of an intervening tank for mixing coagulant or adsorbent with water. In a preferred embodiment, a small tank is used to disperse coagulant or adsorbent in water prior to adding the coagulant or adsorbent dispersion to the water in-line.

Preferably, coagulant is added in an amount from 0.1 to 20 mg/L, based on the volume of the water in-line, preferably at least 1 mg/L, preferably at least 1.5 mg/L; preferably no more than 15 mg/L, preferably no more than 10 mg/L. For inorganic coagulants, the mass in mg is the mass of metal ions. Preferably, adsorbent is added in an amount from 5 to 100 mg/L, based on the volume of water in-line, preferably at least 8 mg/L, preferably at least 10 mg/L; preferably no more than 50 mg/L, preferably no more than 30 mg/L. In a preferred embodiment, coagulant may be dispersed in water prior to being added to the water in-line in an amount of 5-15 wt % based on the weight of the dispersion. In a preferred embodiment, adsorbent is dispersed in water prior to being added to the water in-line in an amount from 1 to 100 g/L of water, preferably 5 to 20 g/L.

Preferred coagulants include inorganic coagulants, organic polymeric coagulants and inorganic-polymer complexes. Preferred organic polymeric coagulants are polyamines and poly DADMAC (Diallyl Dimethyl Ammonium Chloride). Preferred inorganic coagulants are ferric chloride, poly(aluminum chloride), aluminum sulfate, and aluminum chloride.

Preferred adsorbents are activated carbon and ion exchange resins, preferably activated carbon. The preferred form of activated carbon is powdered activated carbon (PAC). Preferably, the average particle size of the activated carbon is from 1 to 200 μm, preferably from 5 to 50 μm, preferably from 5 to 20 μm. Preferably, the average surface area of the activated carbon is from 800 to 2000 m²/g, preferably from 900 to 1500 m²/g.

Preferably, the membrane is a UF membrane. Preferably, the membrane is one suitable to be used in an “inside-out” configuration, i.e., water travels through a passage inside the membrane and treated water flows through to the outside, preferably a multi-bore fiber membrane containing several capillaries in a single fiber. Preferably, the inside diameter of the capillaries is from 0.2 mm to 2 mm, preferably 0.5 mm to 1.5 mm. Preferably, the membrane comprises polyethersulfone (PES). UF membranes in general are well known in the field of waste water treatment.

### EXAMPLE

The combination of alternating addition of a coagulant and an adsorbent were tested for treating the effluent of a municipal wastewater treatment plant. The treatment process of the municipal wastewater treatment plant consisted of a strainer, a clarifier, the biological treatment with nitrification and denitrification, and a final clarifier. The secondary effluent had the following water quality parameters:

| | | | |
|---|---|---|---|
| Temperature | ° C. | 10-16 | Endress + Hauser, |
| | | | Orbisint CPS11 |
| pH | UpH | 7.0-7.1 | Endress + Hauser, |
| | | | Orbisint CPS11 |
| Turbidity | NTU | 2-25 | Hach Lange, |
| | | | ULTRATURB plus sc, |
| | | | DIN EN ISO 7027 |
| COD | mg/L | 30 | DIN 38409-H41-1 |
| DOC | mg/L | 5.0-8.5 | DIN EN 1484 (H 3) |
| UV_{254 nm} | m⁻¹ | 18-22 | DIN 38404-C3 |

The adsorbent was powdered activated carbon (PAC) which had particles with a mean diameter of 10 μm, where 90% are smaller than 45 μm, and an iodine number of 1020 mg/g. 15 mg/L (concentration in the waste water stream) of the PAC were added during dosing. As coagulant a polyaluminumchloride (PACl) with a basicity of 65% was used and added at a concentration of 4 mg/l as of Al³⁺ during dosing. The UF modules used for the study contained inside-to-out Multibore® fibers with seven capillaries with a surface area of 80 m². The inner layer of each capillary (internal diameter of 0.9 mm) represents the very thin active filter surface. The pore size of the filtration layer is approx. 20 nanometers. The material of the Multibore® fibers is modified polyethersulfone (PES). The UF was operated at a flux of 80 l/(m²·h) and a filtration time of 45 min, resulting in a recovery of 91%.

The employed dosing pattern was an alternating dosing, where either the PAC or the PACl have been added upfront to the UF alternatingly here with a delay of 20 seconds between in-line addition and contact with the membrane. The chosen time interval here for PAC as well as for PAC was 3 min.

Over a period of 3 days the normalized permeability @ 20° C. remained stable in a range of 120 to 250 L/(m²·h·bar) with a correlative trans-membrane pressure (TMP) of 400 to 750 mbar.

In comparison, adding only PAC without coagulant resulted in an unstable operation reaching a TMP of 1500 mbar within only 12 hours, whereas the organic fouling was so dominant that a physical cleaning could not recover the permeability.

The removal efficiency by the short-term adsorption of selected micropollutants prior to the UF membrane can be seen in the following overview:

| | | | Inventive |
|---|---|---|---|
| | | Comparative | Alternating |
| | | Continuous | addition: 3 |
| | Comparative | addition of | min. PAC |
| | Continuous | PAC and | alternating |
| | addition | poly- | with 3 min. |
| | of PAC, | (aluminum | poly- (aluminum |
| Micropollutants | no coagulant | chloride) | chloride) |
| Low absorption: | 25% | 12% | 34% |
| Amidotrizoate, | | | |
| Lopamidol, Lopromide | | | |
| Good absorption: | 45% | 33% | 48% |
| Diclofenac, | | | |
| Sulfamethoxazole, | | | |
| Clarithromycin, | | | |
| Naproxen | | | |
| Very good absorption: | 60% | 40% | 61% |
| Bezafibrat, 1H- | | | |
| Benzotriazole, | | | |
| Carbamazepint, | | | |
| Metoprolol | | | |

For the low adsorbable and good adsorbable organic micropollutants the alternating process shows better results, whereas the very good adsorbable organic micropollutants are rather comparable with respect to their removal efficiency for PAC alone and the alternating process, but are removed more efficiently by PAC/poly(aluminum chloride) continuous addition. The additional removal rate by the prior biological treatment step is not shown here.

In summary, the alternating dosing of an adsorbent (PAC), and a coagulant upstream of a PES ultrafiltration membrane results in a stable UF performance in terms of a controllable fouling layer and achieves the highest removal rates of organic micropollutants. On the other hand, sufficient removal rates of micropollutants can also be achieved with the addition of PAC only, however a sharp increase in TMP and a non-reversible fouling layer have been an observed consequence.

1. A method for membrane filtration of water comprising alternating in-line additions of coagulant and adsorbent to the water upstream of the membrane, wherein each addition time is in a range from 10 seconds to one hour.

2. The method of claim 1 wherein a ratio of median addition time for coagulant additions to median addition time for adsorbent additions is from 3:1 to 1:3.

3. The method of claim 2 wherein each addition time is no greater than 30 minutes.

4. The method of claim 3 wherein the adsorbent is activated carbon.

5. The method of claim 4 wherein each addition time is at least 1 minute.

6. The method of claim 5 wherein the coagulant is an inorganic coagulant.

7. The method of claim 6 wherein the activated carbon has an average particle size from 5 to 50 μm and a surface area from 800 to 2000 m²/g.

8. The method of claim 1 wherein each addition time is in a range from 1 minute to 10 minutes.

9. The method of claim 8 wherein the adsorbent is activated carbon.

10. The method of claim 9 wherein a ratio of median addition time for coagulant additions to median addition time for adsorbent additions is from 2:1 to 1:2.

11. The method of claim 10 wherein the coagulant is an inorganic coagulant.
